(19) United States
(12) Patent Application Publication
(10) Pub. No.: US 2018/0224923 A1
(43) Pub. Date: Aug. 9, 2018

(54) LOW POWER KEY PHRASE DETECTION

(71) Applicant: Intel Corporation, Santa Clara, CA (US)

(72) Inventors: Vinu K. Elias, Austin, TX (US); Senaka Cuda Bandara Ratnayake, El Dorado Hills, CA (US); Paul S. Durley, Portland, OR (US); Moorthy Rajesh, Folsom, CA (US); Darren S. Crews, Hillsboro, OR (US)

(21) Appl. No.: 15/427,682

(22) Filed: Feb. 8, 2017

(51) Int. Cl. G06F 1/32; G10L 15/28; G10L 15/08

(52) U.S. Cl. CPC G06F 1/3296; G10L 15/28; G10L 2015/088; G06F 1/3206; G10L 15/08

(57) ABSTRACT

Systems and techniques for lower power key phrase detection are disclosed herein. An audio sample may be captured in a power management integrated circuit (PMIC). Here, the PMIC is physically different than a sensor circuit of an integrated system and the PMIC has a lower power leakage than the sensor circuit. The integrated system may be awoken upon a trigger. The audio sample may then be transferred to the integrated system to perform key phrase detection (KPD). The integrated system may be put to sleep in response to completion of the KPD.

### TECHNICAL FIELD

Embodiments described herein generally relate to low-power devices, and more specifically to system-on-a-chip (SoC) low power key phrase detection (KPD).

### BACKGROUND

There is an increasing demand for wearable devices, and in particular, for voice-activated wearable devices. Voice activation generally includes a number of sensors and processors to sample and interpret voice data to effectuate the voice activation. Often, these functions are implemented in an integrated processing platform, such as SoC designs presently available. SoCs often are designed to handle other tasks, such as communications, sensor interpretation, media playback, or general processing. As such, SoCs tend to be power hungry; reducing their efficacy in low-power device implementations such is often the case with wearables.

### BRIEF DESCRIPTION OF THE DRAWINGS

FIG. 1 is a block diagram of system for KPD, according to an embodiment.

FIG. 2 is a diagram of a sensor hub workflow for KPD, according to an embodiment.

FIG. 3 is a block diagram of a system for low power KPD, according to an embodiment.

FIG. 4 is a diagram of a sensor hub workflow for low power KPD, according to an embodiment.

FIG. 5 is a flow diagram of an example of a method for low power KPD, according to an embodiment.

FIG. 6 is a block diagram illustrating an example of a machine upon which one or more embodiments may be implemented.

### DETAILED DESCRIPTION

SoC and other integrated system developers often encounter the problem of managing platform power drain during key phrase detection (KPD) or wake-on-voice (WoV) use cases. This problem appears in a variety of applications, such as in wearables, phones, tablets, IVI systems, among others.

No-touch wake, such as WoV using KPD, has become a standard platform feature and is trending to be a ubiquitous choice for wearables such as head mounted devices, wireless ear-buds, phones, and tablets. A poor battery life for wearable products supporting KPD may be particularly disliked by consumers. A solution to these problems, described herein, is to separate a KPD implementation from the integrated system to permit more aggressive power savings on the more power-hungry integrated system while maintaining KPD in the KPD subsystem. In an example, the KPD subsystem may include digital microphones (DMICs), memory buffers, and digital signal processors (DSPs) to capture, store, and process audio samples for KPD. A combination of static random access memory (SRAM) or like memory blocks may be included to store voice samples. The KPD subsystem may include an analog audio front-end with DMICs, pulse-density modulation (PDM) to pulse-code modulation (PCM) converters, etc., with a clock source in an “always on power well” to provide significant power savings in many integrated system applications, such as SoC implementations for wearables, for example.

The following description and the drawings sufficiently illustrate specific embodiments to enable those skilled in the art to understand the specific embodiment. Other embodiments may incorporate structural, logical, electrical, process, and other changes. Portions and features of various embodiments may be included in, or substituted for, those of other embodiments. Embodiments set forth in the claims encompass all available equivalents of those claims.

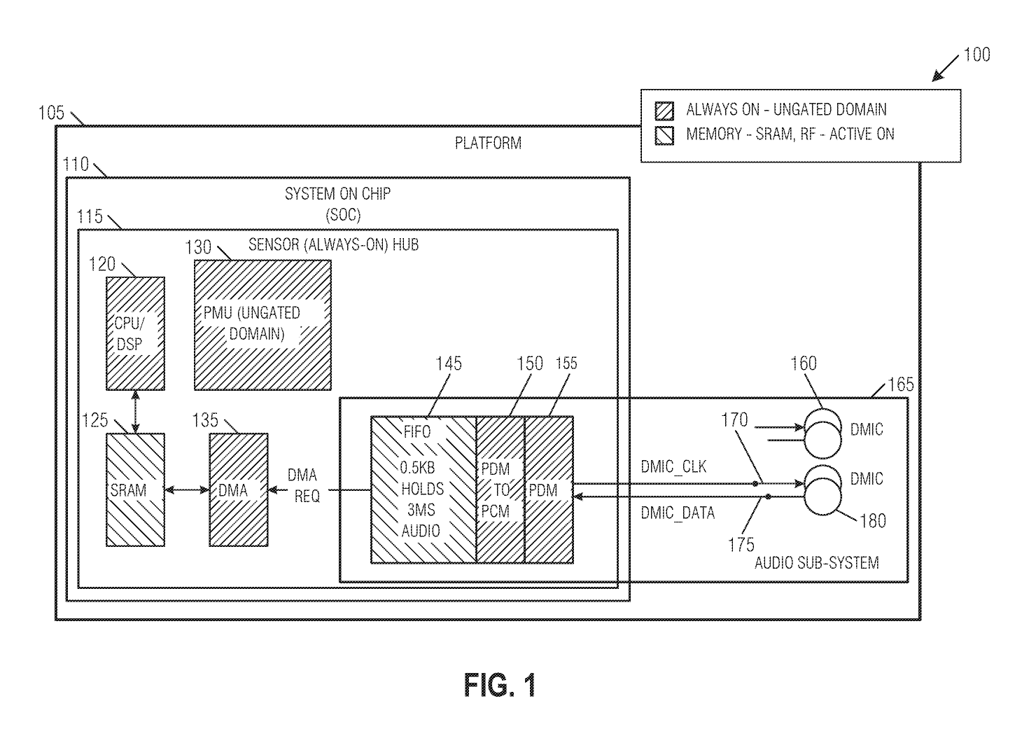

FIG. 1 is a block diagram of a system 100 for KPD, according to an embodiment. The system 100 includes a platform 105, such as a phone, tablet, motherboard, etc., that includes a SoC 110 and an audio subsystem 165. The SoC 110 includes a sensor hub 115. The sensor hub 115, and the components illustrated within, may be manufactured on a single integrated circuit (IC). The sensor hub 115 includes a processor 120 (e.g., central processing unit (CPU), digital signal processor (DSP), etc.), system memory 125 (e.g., static random access memory (SRAM), dynamic RAM (DRAM), etc.), a power management unit (PMU) 130, and a direct memory access (DMA) block 135. The sensor hub 115 may also include components of the audio subsystem 165, such as a first-in-first-out (FIFO) buffer 145, and modulation converters, such as a pulse-density modulation (PDM) block 155 and a PDM to pulse-code modulation (PCM) converter 150. The PDM block 155 may be coupled to digital microphones (DMIC) 160 and 180 via a control wire 170 and a data wire 175 to complete the audio subsystem 165.

In operation, the system 100 includes several components that are “always on,” or receive power, in order to capture audio and perform KPD. These components include the PMU 130, the processor 120, and DMA block 135, the PDM block 155, and the PDM to PCM converter 150. In an addition, the system memory 125 and FIFO buffer 145 are powered when active, which is whenever they are storing information, such as audio samples captured by the audio subsystem 165. The remaining sensor hub 115 components may be powered off, or put into a reduced power state, to achieve KPD.

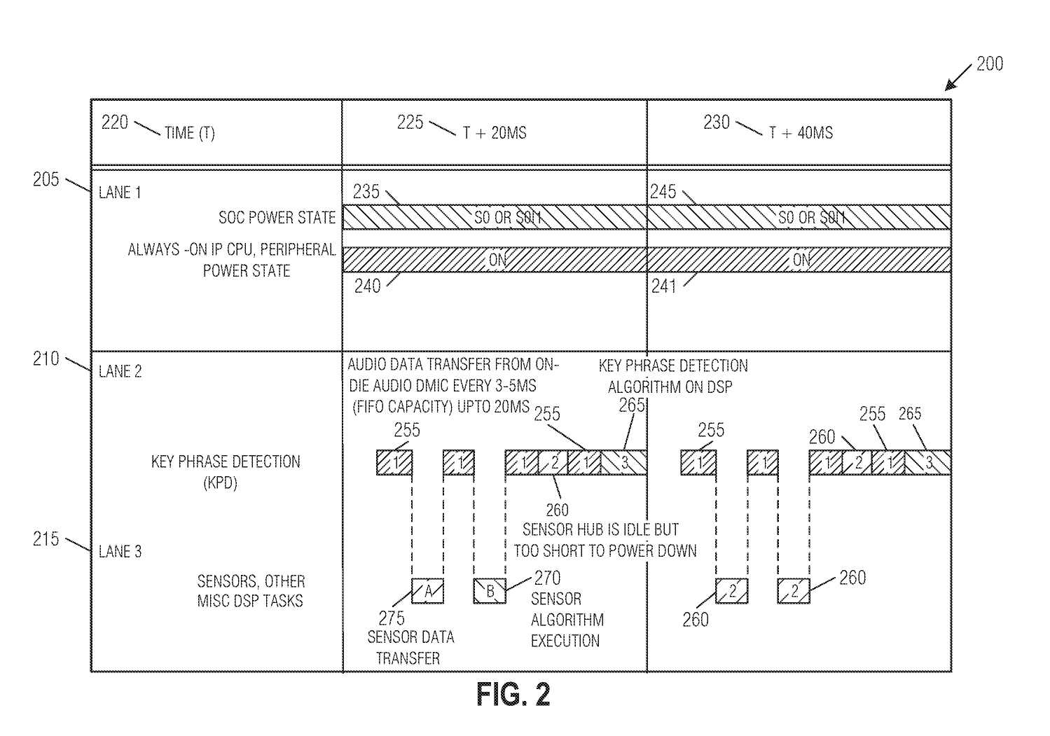

FIG. 2 is a diagram of a sensor hub workflow 200 for KPD, according to an embodiment. The diagram includes time steps 220, 225, and 230, with time step 220 starting at a given time, time step 225 starting twenty milliseconds after time step 220, and time step 230 starting forty milliseconds after time step 220. The diagram also includes three lanes 205, 210, and 215 to distinguish between distinct components and their respective power states in time steps 220, 225, and 230. Specifically, lane one 205 illustrates a reduced power state (S0 or S0i1) for the SoC in time steps 225 (power bar 235) and 230 (power bar 245) while the sensor hub IC remains in an always on states for these time states as illustrated at power bars 240 and 241. Lanes two 210 and three 215 illustrate why the sensor hub IC remains powered on to handle KPD. In short, however, there is no break in sensor hub IC component activity during KPD to allow the sensor hub IC to enter a lower power state.

Lane two 210 illustrates KPD specific tasks that integrate with the sensor or miscellaneous tasks to support KPD that are illustrated in lane three 215. The KPD system initiates transfer of audio data from the microphones at an interval, such as every three to five milliseconds and possibly up to every twenty milliseconds (operation 255). The data is transferred (operation 275) to the KPD system, including, for example, performing the PDM to PCM conversion (operation 270). Because audio collection is constant (or nearly so), and the FIFO buffer tends to be small, the transfer of audio information may iterate several times before there is enough audio information captured to perform KPD. When there is enough audio data, KPD is performed (operation 265) and the process repeats in time step 230.

In an example, once KPD is turned on, the audio processing takes precedence and tasks such as DMA transfer requests will be at the highest priority. Other tasks such as other sensor data transfer, processing, or firmware (FW) housekeeping tasks will be limited to time windows in between audio sample transfers. The Audio FIFO on-die may capture up to three to five milliseconds (e.g., depending on FIFO size, which directly contributes to area and power) of audio in a sample and generate a DMA request to flush the buffer into the system memory. This is illustrated in lane two 210 as the data transfer request block 275.

Observations from the workflow 200 may include that many components are at full power for entire time. The SoC tends to stay in a higher power state than it otherwise could due to the inclusion of the sensor hub in the SoC. The lane two 210 audio and lane three 215 sensor portions may not be active for the entire period (e.g., periods 260), but between the two the sensor hub is powered to meet the audio capture and processing tasks for KPD. For example, because the FIFO is generally shallow, windows of audio collection tend to be between three to five milliseconds and samples are continually moved to the larger system memory of the SoC. Thus, it is generally not possible to shut the sensor hub off because either audio is being captured or there is some KPD processing to perform. Further, although there may be periods in which the sensor hub may be powered down, there is no net energy saved if the window is too short, which is typically the case.

The system 100 and workflow 200 described above represent KPD operations that may be found in a variety of applications. An example of such as application may include using a minimum time-slice worth of audio samples captured at a sampling rate using two to four microphone channels to detect presence of a human voice. In an example, twenty millisecond samples of sixteen kilobits per second (Kbps) for four microphones may be used. In this example, the sample for the twenty milliseconds consume about three kilobits (KB) of system memory.

In an example, digital microphones may use an oversampling digital format such as PDM transfer this into the SoC. In an example, SoC logic blocks may convert the PDM format to simpler format, such as PCM. The PCM audio may then be transferred into SoC system memory for KPD processing by, for example, a DSP. In an example, the digital processing logic may use its own clock source. In an example, the clock source may have a frequency of 38.4 megahertz (MHz) for KPD.

In these systems, when the user turns on the KPD at, for example, the operating system (OS) level, a sensor hub IC on the SoC with an audio front-end generally will be turned on to continuously collect audio samples. Memory, DSP, and clock distribution are prime power consuming contributors to run the KPD. Often, the power consumption in these configurations may range from nine to ten milliwatts (mW) at the platform level.

Intelligently partitioning the components of the system 100 may provide opportunities to bring more components into a low power state while still enabling robust KPD. Specifically, audio capture front-end portions may be separated from the always on hub and relocated into a power management IC (PMIC). The PMIC may include its own clock and ungated power well. Data exchange between the audio components and the sensor hub may be achieved via a serial peripheral interface (SPI). With this arrangement, the sensor hub may be completely shut down (e.g., powered off) while audio samples are being captured using the PMIC. This will also allow the SoC to enter S0i3 or deep power suspend modes and for power rails to be lowered to a retention voltage level.

Because portions of the sensor hub will still be used in KPD, a programmable timer (e.g., real time clock (RTC)), for example running at thirty-two kilohertz, may be used to generate a wake signal to the sensor hub. When the timer produces a wake trigger, or other wake trigger is issued, the processor in the sensor hub may be powered up to operate a dedicated SPI port and to transfer the audio sample into SRAM memory for KPD processing.

By separating the PMIC from the sensor hub (and the SoC in general), a different manufacturing process, for example, based on larger feature sizes may be used. Larger feature sizes in ICs generally have lower power leakage and thus may result in additional power savings for the system. For example, The FIFO or memory allocation in the PMIC, which may have an order of magnitude lower leakage than if it were located in the SoC, may be increased to three KB to accommodate an entire twenty milliseconds of audio capture. By reducing the number of audio samples to transfer into the SoC system memory, the number of times the sensor hub is awaken is reduced, allowing the SoC longer residency in S0i3, or other reduced power state, for example.

This arrangement does not degrade KPD performance because the sensor hub is asleep only as the audio samples are collected, being freed from the constant transfer process of the system 100 discussed above. Moreover, even if the sensor hub was not put into a low power state, the system achieves the advantage of freeing the sensor hub to perform other tasks, such as motion sensing. However, on the power savings side, around four milliwatts may be saved by the partitioning of the audio components from the sensor hub as described herein.

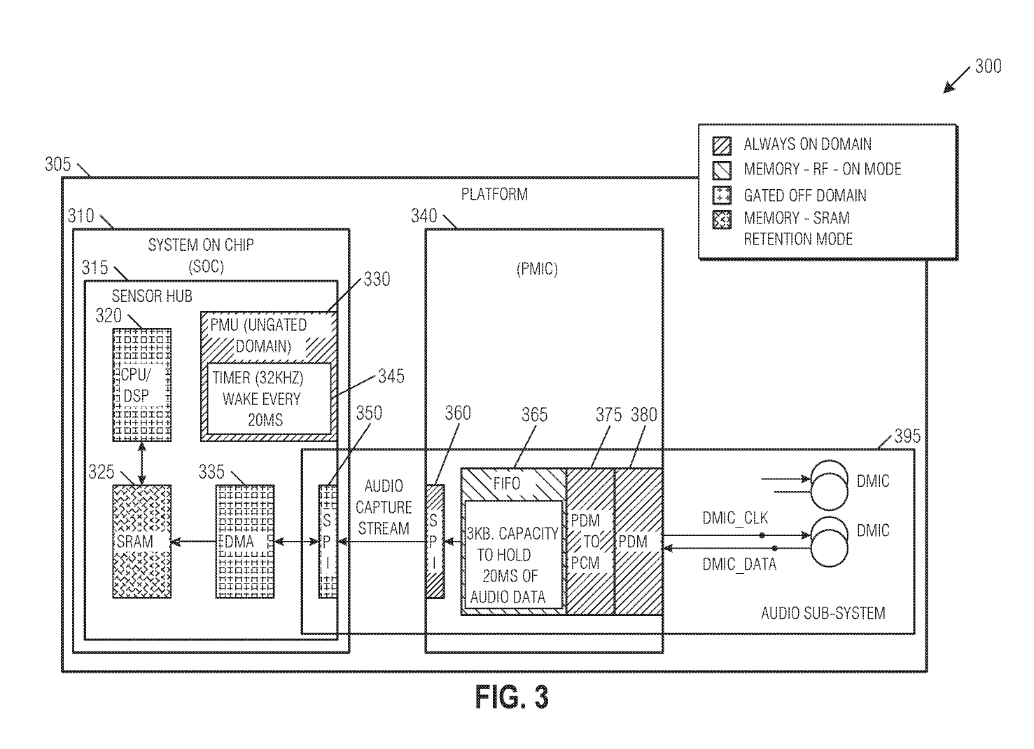

FIG. 3 is a block diagram of a system 300 for low power KPD, according to an embodiment. A difference between the system 300 and the system 100 is the new PMIC 340—of the platform 305—that is separate from the SoC 310. As in system 100, the SoC 110 includes a sensor hub 315, and the sensor hub 315 may include a processor 320, a PMU 330, system memory device 325, and a DMA block 335. Added to the SoC 110 are a timer 345 in, for example, the PMU 330, and an SPI 350. The system 300 also includes an audio sub-system 395 that includes components in both the PMIC 340 and the integrated system 310.

As illustrated, the PMIC 340 is physically separated from the sensor hub (e.g., circuit) 315 of the integrated system (e.g., SoC) 310, and thus from the clock of the sensor hub 315. In an example, the clock (of the PMIC 340) operates at a reduced frequency than an integrated system clock of the integrated system 310. In an example, the reduced frequency is thirty-eight point four megahertz.

In an example, the PMIC 340 has a lower power leakage than the sensor hub. This may be accomplished with, for example, a manufacturing process with larger feature sizes typically of older processes. In an example, the PMIC has a feature size of sixty-five nanometers (as opposed to a fourteen nanometer process of the SoC 310).

In operation, the PMIC 340 may be arranged to capture an audio sample. In an example, the PMIC 340 includes the FIFO buffer 365. In this example, capturing the audio sample includes storing input from the array of microphones (e.g., DMICs) into the FIFO buffer 365. In an example, a portion of the audio sample is stored in the FIFO buffer 365. In an example, the PMIC 340 may be arranged to determine that a FIFO trigger is activated. This may occur, for example, if the FIFO is full, or past a threshold. In an example, the PMIC 340 is arranged to transfer the portion of the audio signal to the memory device 325 (e.g., via DMA block 335 and SPI ends 350 and 360) of the integrated system 310. In an example, the portion of the audio sample is in an inclusive range of three to five milliseconds. In an example, the length of the audio sample is twenty milliseconds. In an example, the size of the FIFO buffer 365 is three kilobits.

The PMIC 340 is arranged to transform the audio sample from a first format into a second format to create a simplified audio signal. In an example, the first format is PDM, captured, for example, at the PDM block 380. In an example, the second format is PCM. The transformation may be carried out, for example, by the PDM to PCM converter 375.

The integrated system 310 may be awoken in whole or in part (e.g., just the sensor hub 315) at an interval determined by the timer 345. In an example, the timer 345 is in the integrated system 310 (as illustrated). In an example, the timer 345 is in the PMIC 340. In an example, the timer 345 operates at thirty-two kilohertz. In an example, the interval is twenty milliseconds.

The simplified audio signal may be transferred to the integrated system 310 to perform KPD. In an example, the transfer using DMA (e.g., block 335) to transfer the portion of the audio sample to the memory device 325. In an example, the memory device 325 is a SRAM device. In an example, the integrated system 310 prioritizes DMA transfers from the PMIC 340 over other DMA transfers. In an example, the other DMA transfers are limited to DMA transfers by sensors.

In an example, transferring the simplified audio includes using the SPI. Here, the PMIC 340 includes a first SPI endpoint 360 communicatively coupled to a second SPI endpoint 350 in the integrated system.

The integrated system 310 is put to sleep in response to completion of the KPD. In an example, putting the integrated system 310 to sleep includes causing the memory device 325 to enter a retention mode. In an example, putting the integrated system 310 to sleep includes gating off a portion of the integrated system 310. In an example, the portion is the sensor hub 315 of the integrated system 310.

The system 300 provides a number of benefits over the system 100 discussed above. In summary, based on the various examples discussed above, the partition of power-consuming blocks from the SoC 310 into the PMIC 340 may result in significant power savings while still enabling an always on KPD. For example, the proposed partitioning allows a manufacturing process for the PMIC 340 that leaks less power than that of the SoC 310. Further, the benefit of this lower power leakage allows for a greater FIFO buffer 365 (e.g., three kilobits rather than one-half kilobit), reducing the number of times that the SoC 310 or the sensor hub 315 is awoken. Thus, as opposed to the system 100, the SoC 310 or the sensor hub 315 may actually be put to sleep. Because the partitioning removes audio processing (e.g., sense and capture) and no other KPD functions from the SoC 310, the SoC 310 or the sensor hub 315 is awoken to complete KPD. As noted above, this may be a self-awaking (e.g., via the timer 345) or triggered by the PMIC 340 (e.g., a FIFO trigger). SPI may be used to drain the FIFO buffer 365 during the wake periods and is capable of transferring the three kilobits of the FIFO buffer 365 during this period.

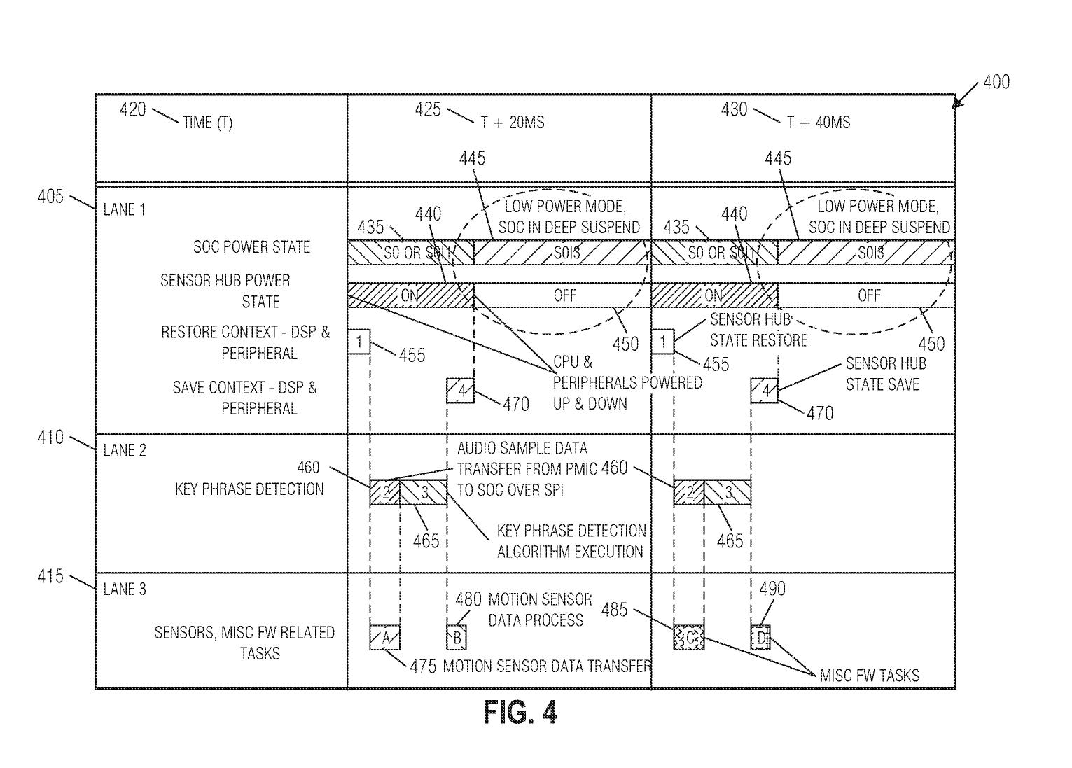

FIG. 4 is a diagram of a sensor hub workflow 400 for low power KPD, according to an embodiment. The workflow 400 illustrates powered operations for the system 300 across time, much like the workflow 200 illustrated for system 100. Similar to workflow 200, the illustration is vertically divided by twenty milliseconds time intervals starting at time 420, moving to time 425, and ending at time 430. These cycles of time may be continually repeated for continuous KPD.

Lane one 405 illustrates power-state transitions of an integrated system (e.g., SoC) based sensor hub. These power transitions also influence the power transitions of the integrated system (also illustrated). In an example, sensor hub may save state and is power gated. In an example, a programmable timer based wake pulse may power ungate and restore a processor (e.g., DSP) state for the sensor hub.

Lane two 410 illustrates a data transfer phase over SPI and KPD processing flow by the sensor hub.

Lane three 415 illustrates time sharing of sensor hub processor bandwidth across different tasks. As noted above, the system 300 allows for task execution without interruption while audio transfers occur over the SPI. Thus, audio transfer requests may be prioritized over other tasks, such as motion sensor processing, without penalty.

An example performance of the power cycling and task performance starts with the integrated system at a reduced power state of S0 or S0i1 435 while the sensor hub is powered on 440 to restore is processor's state (operation 455), transfer an audio sample from the PMIC (operation 460)—causing the data to be transferred from the PMIC, such as via DMA, (operation 475), perform KPD (operation 465), and save the processor context (operation 470). At this point the processor hub may power down 450 until, for example, an additional audio sample period (e.g., twenty milliseconds) or other trigger (e.g., FIFO buffer fill) occurs. As the processor hub powers down, the integrated system may enter an even more reduced power state 445 of S0i3, for example.

The process is repeated in the last time step 430 except that some operations, such as miscellaneous sensor tasks 485 and 490, or other sensor tasks (e.g., motion sensor data processing at operation 480) may be performed instead of the audio sample transfer. This illustrates the flexibility provided by the system 300.

The partitioning of components described in the system 300 allows the sensor hub on integrated system to be power gated during each audio sample transfer interval. This, in turn, allows the integrated system to enter a reduced power state, such as S0i3. Further, there is zero penalty to sensor hub processor bandwidth due to the buffer repartition (e.g., increasing the FIFO size) and zero performance change to support the KPD flow.

The described partitioning and component relocation should not be interpreted as moving the power problem from the integrated system into another area of the platform because the PMIC is likely already powered for other tasks, such as universal serial bus cable detection logic. Thus, locating additional always on components, such as the audio sample capturing into the PMIC, is an efficient allocation of power. Further, PMICs generally use manufacturing process technology that has much lower leakage than standard SoC integrated systems. This provides a benefit when moving memory buffers into this power well; allowing for an increase the FIFO size—for example, to accommodate the complete audio sample size (e.g., 20 ms worth of audio sample)—dramatically reducing the frequency at which the sensor hub or integrated system will wake. The increased residency in a reduced power state results in additional power savings.

Shutting down the sensor hub provides power saving benefits to the integrated system by, for example, eliminating support functions such as clock maintenance. Again, this allows the integrated system to enter a deeper level of power reduction than would otherwise be possible.

All of these benefits are achieved without a perceived drop in KPD performance and without additional overhead on the sensor hub or its processors during audio sample data transfer due to the effective employ of DMA.

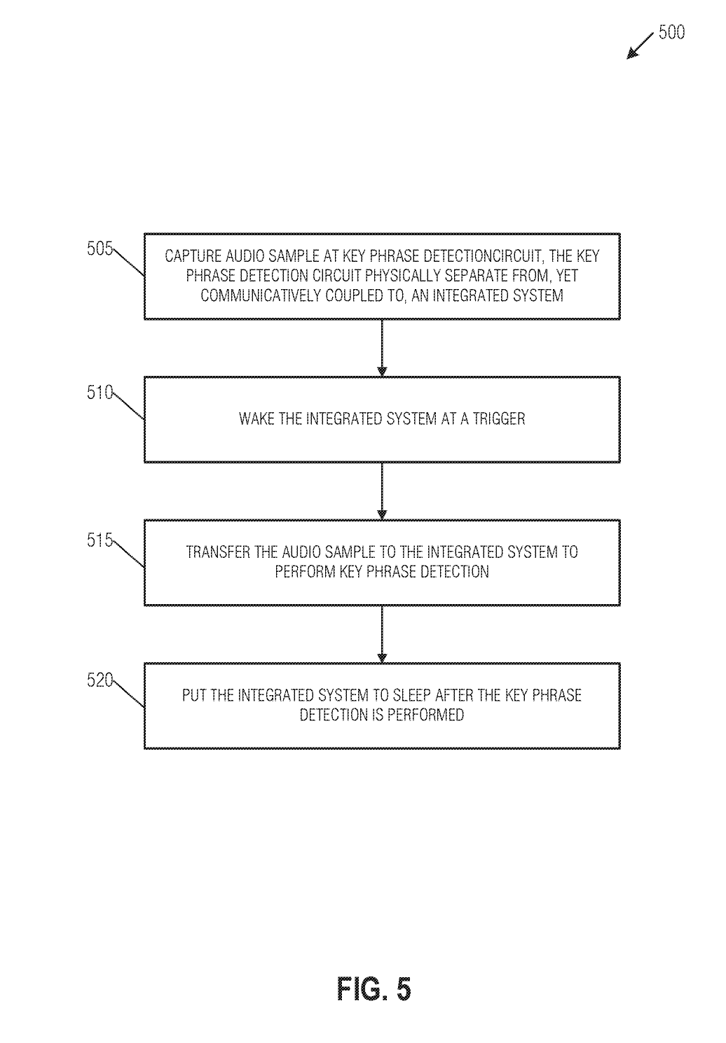

FIG. 5 is a flow diagram of an example of a method 500 for low power KPD, according to an embodiment. The operations of the method 500 are performed by electronic hardware, such as that described above, or below (e.g., circuits).

At operation 505, an audio sample may be captured in a power management integrated circuit (PMIC). Here, the PMIC is physically separated from a sensor circuit (e.g., in a different IC) of an integrated system and having a lower power leakage than the sensor circuit. Also, in an example, the integrated system is a system-on-a-chip (SOC) of a device and the PMIC is part of the same device.

In an example, PMIC includes a FIFO buffer separate from other components of the integrated system. In an example, capturing the audio sample includes storing input from an array of microphones into the FIFO buffer of the PMIC. In an example, storing input from the array of microphones includes determining that a FIFO threshold is reached and activating a FIFO trigger, as the trigger, in response. In an example, the length of the audio sample is twenty milliseconds. In an example, the size of the FIFO buffer is three kilobits.

At operation 510, the integrated system may be awoken upon a trigger. In an example, the trigger is activated at an interval determined by a timer. In an example, the timer is in the integrated system. In an example, the timer is in the PMIC. In an example, the timer operates at thirty-two kilohertz. In an example, the interval is twenty milliseconds.

At operation 515, the audio sample may be transferred to the integrated system to perform KPD. In an example, transferring the audio sample includes using DMA to effect the transfer to the memory device. In an example, the integrated system prioritizes DMA transfers from the PMIC over other DMA transfers. In an example, the other DMA transfers are limited to DMA transfers by sensors. In an example, the memory device is a static random access memory (SRAM) device.

In an example, the method 500 may be extended to transform the audio sample from a first format into a second format prior to transferring the audio sample from the PMIC to the integrated system. In an example, the first format is PDM. In an example, the second format is PCM.

In an example, transferring the audio sample includes using a SPI. Here, the PMIC includes a first SPI endpoint communicatively coupled to a second SPI endpoint in the integrated system.

At operation 520, the integrated system may be put to sleep in response to completion of the KPD. In an example, putting the integrated system to sleep includes causing the memory device to enter a retention mode. In an example, putting the integrated system to sleep includes gating off a portion of the integrated system. In an example, the portion is the sensor circuit of the integrated system

In an example, the PMIC is created with a sixty-five nanometer process. In an example, the clock operates at a reduced frequency than an integrated system clock. In an example, wherein the reduced frequency is thirty-eight point four megahertz.

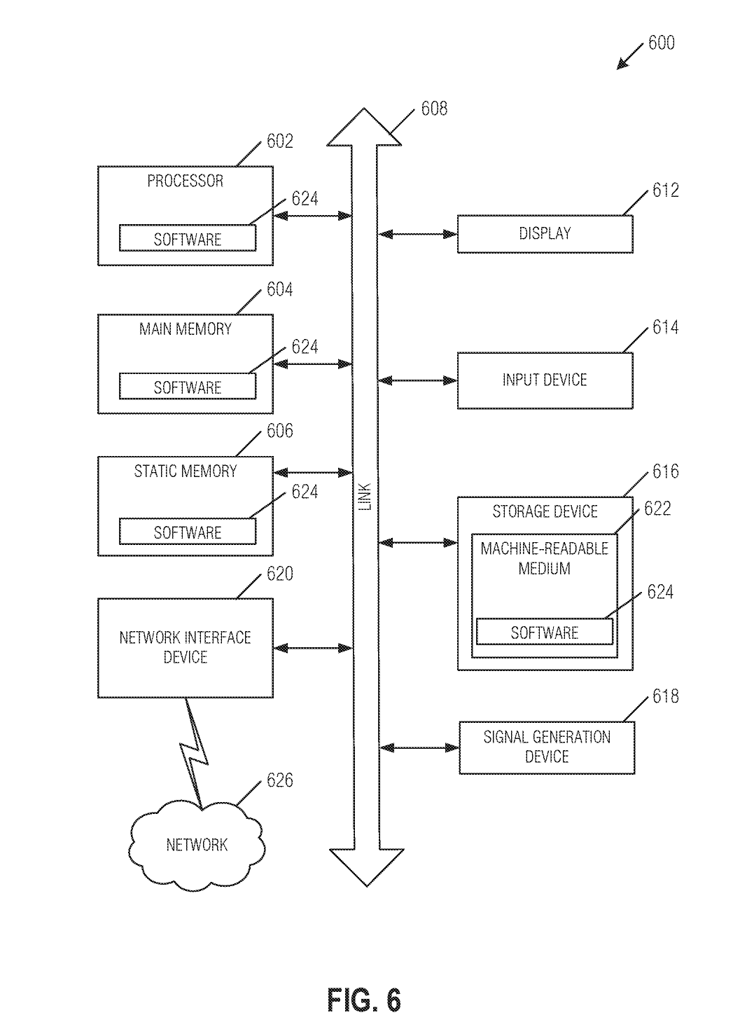

FIG. 6 is a block diagram illustrating a wearable key phrase detection SOC device in the example form of an electronic device 600, within which a set or sequence of instructions may be executed to cause the machine to perform any one of the methodologies discussed herein, according to an example embodiment. The electronic device 600 operates as a standalone device or may be connected (e.g., networked) to other machines. In a networked deployment, the electronic device 600 may operate in the capacity of either a server or a client machine in server-client network environments, or it may act as a peer machine in peer-to-peer (or distributed) network environments. The electronic device 600 may be an integrated circuit (IC), a portable electronic device, a personal computer (PC), a tablet PC, a hybrid tablet, a personal digital assistant (PDA), a mobile telephone, or any electronic device 600 capable of executing instructions (sequential or otherwise) that specify actions to be taken by that machine to detect a user input. Further, while only a single electronic device 600 is illustrated, the terms “machine” or “electronic device” shall also be taken to include any collection of machines or devices that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to execute instructions, individually or jointly, to perform any one or more of the methodologies discussed herein.

Example electronic device 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus).

The electronic device 600 may include a display unit 612, where the display unit 612 may include a single component that provides a user-readable display and a protective layer, or another display type. The electronic device 600 may further include an input device 614, such as a pushbutton, a keyboard, an NFC card reader, or a user interface (UI) navigation device (e.g., a mouse or touch-sensitive input). The electronic device 600 may additionally include a storage device 616, such as a drive unit. The electronic device 600 may additionally include a signal generation device 618 to provide audible or visual feedback, such as a speaker to provide an audible feedback or one or more LEDs to provide a visual feedback. The electronic device 600 may additionally include a network interface device 620, and one or more additional sensors (not shown), such as a global positioning system (GPS) sensor, compass, accelerometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the electronic device 600. The main memory 604, static memory 606, and the processor 602 may also constitute machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet mobile telephone networks, and wireless data networks (e.g., Wi-Fi, NFC, Bluetooth, Bluetooth LE, 3G, 3G LTE/LTE-A, WiMAX networks, etc.). The term “transmission medium” shall be taken to include any intangible medium that is capable of storing, encoding, or carrying instructions for execution by the machine, and includes digital or analog communications signals or other intangible medium to facilitate communication of such software.

To better illustrate the method and apparatuses disclosed herein, a non-limiting list of embodiments is provided here.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

### ADDITIONAL NOTES & EXAMPLES

Example 1 is a system for low power key phrase detection (KPD), the system comprising: a sensor circuit in an integrated system; and a power management integrated circuit (PMIC) that is physically different than the sensor circuit and has a low power leakage that the sensor circuit, the PMIC to: capture an audio sample; and transfer the audio sample to the integrated system to perform KPD when the integrated system is awake, wherein the integrated system is awoken upon a trigger, and wherein the integrated system is put to sleep in response to completion of the KPD.

In Example 2, the subject matter of Example 1 optionally includes wherein the integrated system is a system-on-a-chip (SOC) of a device, the PMIC being a part of the device.

In Example 3, the subject matter of any one or more of Examples 1-2 optionally include wherein the PMIC includes a first-in-first-out (FIFO) buffer separate from other components of the integrated system, and wherein, to capture the audio sample, the PMIC is to store input from an array of microphones into the FIFO buffer.

In Example 4, the subject matter of Example 3 optionally includes wherein, to store input from the array of microphones, the PMIC is to: determine that a FIFO threshold is reached, and activate a FIFO trigger as the trigger.

In Example 5, the subject matter of any one or more of Examples 1-4 optionally include wherein, to transfer the audio sample, the PMIC is to use direct memory access (DMA) to transfer the audio sample to the memory device.

In Example 6, the subject matter of Example 5 optionally includes wherein the memory device is a static random access memory (SRAM) device.

In Example 7, the subject matter of Example 6 optionally includes wherein, to put the integrated system to sleep, the integrated system causes the SRAM device to enter a retention mode.

In Example 8, the subject matter of any one or more of Examples 5-7 optionally include wherein the integrated system prioritizes DMA transfers from the PMIC over other DMA transfers.

In Example 9, the subject matter of Example 8 optionally includes wherein the other DMA transfers are limited to DMA transfers by sensors.

In Example 10, the subject matter of any one or more of Examples 1-9 optionally include wherein, to transfer the audio sample, the PMIC is to use a serial peripheral interface (SPI), the PMIC including a first SPI endpoint communicatively coupled to a second SPI endpoint in the integrated system.

In Example 11, the subject matter of any one or more of Examples 1-10 optionally include wherein the PMIC is to transform the audio sample from a first format into a second format prior to transferring the audio sample to the integrated system.

In Example 12, the subject matter of Example 11 optionally includes wherein the first format is pulse-density modulation.

In Example 13, the subject matter of any one or more of Examples 11-12 optionally include wherein the second format is pulse-code modulation.

In Example 14, the subject matter of any one or more of Examples 1-13 optionally include wherein the trigger is activated at an interval determined by a timer.

In Example 15, the subject matter of Example 14 optionally includes wherein the timer operates at thirty-two kilohertz.

In Example 16, the subject matter of any one or more of Examples 14-15 optionally include wherein the interval is twenty milliseconds.

In Example 17, the subject matter of any one or more of Examples 14-16 optionally include wherein the timer is in the integrated system.

In Example 18, the subject matter of any one or more of Examples 14-17 optionally include wherein the timer is in the PMIC.

In Example 19, the subject matter of any one or more of Examples 1-18 optionally include wherein a length of the audio sample is twenty milliseconds.

In Example 20, the subject matter of any one or more of Examples 1-19 optionally include wherein the PMIC operates on a clock separate from the integrated system.

In Example 21, the subject matter of Example 20 optionally includes wherein the clock operates at a reduced frequency than an integrated system clock.

In Example 22, the subject matter of Example 21 optionally includes wherein the reduced frequency is thirty-eight point four megahertz.

In Example 23, the subject matter of any one or more of Examples 1-22 optionally include wherein the PMIC is created with a sixty-five nanometer process.

In Example 24, the subject matter of any one or more of Examples 1-23 optionally include wherein, to put the integrated system to sleep, the integrated system is to gate off a portion of the integrated system.

In Example 25, the subject matter of Example 24 optionally includes wherein the portion is the sensor circuit of the integrated system.

Example 26 is a method for low power key phrase detection (KPD), the method comprising: capturing an audio sample in a power management integrated circuit (PMIC), the PMIC being physically different than a sensor circuit of an integrated system and having a lower power leakage than the sensor circuit; waking the integrated system upon a trigger; transferring the audio sample to the integrated system to perform KPD; and putting the integrated system to sleep in response to completion of the KPD.

In Example 27, the subject matter of Example 26 optionally includes wherein the integrated system is a system-on-a-chip (SOC) of a device, the PMIC being a part of the device.

In Example 28, the subject matter of any one or more of Examples 26-27 optionally include wherein the PMIC includes a first-in-first-out (FIFO) buffer separate from other components of the integrated system, and wherein capturing the audio sample includes storing input from an array of microphones into the FIFO buffer.

In Example 29, the subject matter of Example 28 optionally includes wherein storing input from the array of microphones includes: determining that a FIFO threshold is reached; and activating a FIFO trigger as the trigger.

In Example 30, the subject matter of any one or more of Examples 26-29 optionally include wherein transferring the audio sample includes using direct memory access (DMA) to transfer the audio sample to the memory device.

In Example 31, the subject matter of Example 30 optionally includes wherein the memory device is a static random access memory (SRAM) device.

In Example 32, the subject matter of Example 31 optionally includes wherein putting the integrated system to sleep includes causing the SRAM device to enter a retention mode.

In Example 33, the subject matter of any one or more of Examples 30-32 optionally include wherein the integrated system prioritizes DMA transfers from the PMIC over other DMA transfers.

In Example 34, the subject matter of Example 33 optionally includes wherein the other DMA transfers are limited to DMA transfers by sensors.

In Example 35, the subject matter of any one or more of Examples 26-34 optionally include wherein transferring the audio sample includes using a serial peripheral interface (SPI), the PMIC including a first SPI endpoint communicatively coupled to a second SPI endpoint in the integrated system.

In Example 36, the subject matter of any one or more of Examples 26-35 optionally include transforming, by the PMIC, the audio sample from a first format into a second format prior to transferring the audio sample to the integrated system.

In Example 37, the subject matter of Example 36 optionally includes wherein the first format is pulse-density modulation.

In Example 38, the subject matter of any one or more of Examples 36-37 optionally include wherein the second format is pulse-code modulation.

In Example 39, the subject matter of any one or more of Examples 26-38 optionally include wherein the trigger is activated at an interval determined by a timer.

In Example 40, the subject matter of Example 39 optionally includes wherein the timer operates at thirty-two kilohertz.

In Example 41, the subject matter of any one or more of Examples 39-40 optionally include wherein the interval is twenty milliseconds.

In Example 42, the subject matter of any one or more of Examples 39-41 optionally include wherein the timer is in the integrated system.

In Example 43, the subject matter of any one or more of Examples 39-42 optionally include wherein the timer is in the PMIC.

In Example 44, the subject matter of any one or more of Examples 26-43 optionally include wherein a length of the audio sample is twenty milliseconds.

In Example 45, the subject matter of any one or more of Examples 26-44 optionally include wherein the PMIC operates on a clock separate from the integrated system.

In Example 46, the subject matter of Example 45 optionally includes wherein the clock operates at a reduced frequency than an integrated system clock.

In Example 47, the subject matter of Example 46 optionally includes wherein the reduced frequency is thirty-eight point four megahertz.

In Example 48, the subject matter of any one or more of Examples 26-47 optionally include wherein the PMIC is created with a sixty-five nanometer process.

In Example 49, the subject matter of any one or more of Examples 26-48 optionally include wherein putting the integrated system to sleep includes gating off a portion of the integrated system.

In Example 50, the subject matter of Example 49 optionally includes wherein the portion is the sensor circuit of the integrated system.

Example 51 is at least one machine readable medium including instructions that, when executed by a machine, cause the machine to perform any method of Examples 26-50.

Example 52 is a system comprising means to perform any method of Examples 26-50.

Example 53 is at least one machine readable medium including instructions for low power key phrase detection (KPD), the instructions, when executed by a machine, cause the machine to perform operations comprising: capturing an audio sample in a power management integrated circuit (PMIC), the PMIC being physically different than a sensor circuit of an integrated system and having a lower power leakage than the sensor circuit; waking the integrated system upon a trigger; transferring the audio sample to the integrated system to perform KPD; and putting the integrated system to sleep in response to completion of the KPD.

In Example 54, the subject matter of Example 53 optionally includes wherein the integrated system is a system-on-a-chip (SOC) of a device, the PMIC being a part of the device.

In Example 55, the subject matter of any one or more of Examples 53-54 optionally include wherein the PMIC includes a first-in-first-out (FIFO) buffer separate from other components of the integrated system, and wherein capturing the audio sample includes storing input from an array of microphones into the FIFO buffer.

In Example 56, the subject matter of Example 55 optionally includes wherein storing input from the array of microphones includes: determining that a FIFO threshold is reached; and activating a FIFO trigger as the trigger.

In Example 57, the subject matter of any one or more of Examples 53-56 optionally include wherein transferring the audio sample includes using direct memory access (DMA) to transfer the audio sample to the memory device.

In Example 58, the subject matter of Example 57 optionally includes wherein the memory device is a static random access memory (SRAM) device.

In Example 59, the subject matter of Example 58 optionally includes wherein putting the integrated system to sleep includes causing the SRAM device to enter a retention mode.

In Example 60, the subject matter of any one or more of Examples 57-59 optionally include wherein the integrated system prioritizes DMA transfers from the PMIC over other DMA transfers.

In Example 61, the subject matter of Example 60 optionally includes wherein the other DMA transfers are limited to DMA transfers by sensors.

In Example 62, the subject matter of any one or more of Examples 53-61 optionally include wherein transferring the audio sample includes using a serial peripheral interface (SPI), the PMIC including a first SPI endpoint communicatively coupled to a second SPI endpoint in the integrated system.

In Example 63, the subject matter of any one or more of Examples 53-62 optionally include wherein the operations comprise transforming, by the PMIC, the audio sample from a first format into a second format prior to transferring the audio sample to the integrated system.

In Example 64, the subject matter of Example 63 optionally includes wherein the first format is pulse-density modulation.

In Example 65, the subject matter of any one or more of Examples 63-64 optionally include wherein the second format is pulse-code modulation.

In Example 66, the subject matter of any one or more of Examples 53-65 optionally include wherein the trigger is activated at an interval determined by a timer.

In Example 67, the subject matter of Example 66 optionally includes wherein the timer operates at thirty-two kilohertz.

In Example 68, the subject matter of any one or more of Examples 66-67 optionally include wherein the interval is twenty milliseconds.

In Example 69, the subject matter of any one or more of Examples 66-68 optionally include wherein the timer is in the integrated system.

In Example 70, the subject matter of any one or more of Examples 66-69 optionally include wherein the timer is in the PMIC.

In Example 71, the subject matter of any one or more of Examples 53-70 optionally include wherein a length of the audio sample is twenty milliseconds.

In Example 72, the subject matter of any one or more of Examples 53-71 optionally include wherein the PMIC operates on a clock separate from the integrated system.

In Example 73, the subject matter of Example 72 optionally includes wherein the clock operates at a reduced frequency than an integrated system clock.

In Example 74, the subject matter of Example 73 optionally includes wherein the reduced frequency is thirty-eight point four megahertz.

In Example 75, the subject matter of any one or more of Examples 53-74 optionally include wherein the PMIC is created with a sixty-five nanometer process.

In Example 76, the subject matter of any one or more of Examples 53-75 optionally include wherein putting the integrated system to sleep includes gating off a portion of the integrated system.

In Example 77, the subject matter of Example 76 optionally includes wherein the portion is the sensor circuit of the integrated system.

Example 78 is a system for low power key phrase detection (KPD), the system comprising: means for capturing an audio sample in a power management integrated circuit (PMIC), the PMIC being physically different than a sensor circuit of an integrated system and having a lower power leakage than the sensor circuit; means for waking the integrated system upon a trigger; means for transferring the audio sample to the integrated system to perform KPD; and means for putting the integrated system to sleep in response to completion of the KPD.

In Example 79, the subject matter of Example 78 optionally includes wherein the integrated system is a system-on-a-chip (SOC) of a device, the PMIC being a part of the device.

In Example 80, the subject matter of any one or more of Examples 78-79 optionally include wherein the PMIC includes a first-in-first-out (FIFO) buffer separate from other components of the integrated system, and wherein capturing the audio sample includes storing input from an array of microphones into the FIFO buffer.

In Example 81, the subject matter of Example 80 optionally includes wherein the means for storing input from the array of microphones include: means for determining that a FIFO threshold is reached; and means for activating a FIFO trigger as the trigger.

In Example 82, the subject matter of any one or more of Examples 78-81 optionally include wherein the means for transferring the audio sample include means for using direct memory access (DMA) to transfer the audio sample to the memory device.

In Example 83, the subject matter of Example 82 optionally includes wherein the memory device is a static random access memory (SRAM) device.

In Example 84, the subject matter of Example 83 optionally includes wherein the means for putting the integrated system to sleep include means for causing the SRAM device to enter a retention mode.

In Example 85, the subject matter of any one or more of Examples 82-84 optionally include wherein the integrated system prioritizes DMA transfers from the PMIC over other DMA transfers.

In Example 86, the subject matter of Example 85 optionally includes wherein the other DMA transfers are limited to DMA transfers by sensors.

In Example 87, the subject matter of any one or more of Examples 78-86 optionally include wherein the means for transferring the audio sample include means for using a serial peripheral interface (SPI), the PMIC including a first SPI endpoint communicatively coupled to a second SPI endpoint in the integrated system.

In Example 88, the subject matter of any one or more of Examples 78-87 optionally include means for transforming, by the PMIC, the audio sample from a first format into a second format prior to transferring the audio sample to the integrated system.

In Example 89, the subject matter of Example 88 optionally includes wherein the first format is pulse-density modulation.

In Example 90, the subject matter of any one or more of Examples 88-89 optionally include wherein the second format is pulse-code modulation.

In Example 91, the subject matter of any one or more of Examples 78-90 optionally include wherein the trigger is activated at an interval determined by a timer.

In Example 92, the subject matter of Example 91 optionally includes wherein the timer operates at thirty-two kilohertz.

In Example 93, the subject matter of any one or more of Examples 91-92 optionally include wherein the interval is twenty milliseconds.

In Example 94, the subject matter of any one or more of Examples 91-93 optionally include wherein the timer is in the integrated system.

In Example 95, the subject matter of any one or more of Examples 91-94 optionally include wherein the timer is in the PMIC.

In Example 96, the subject matter of any one or more of Examples 78-95 optionally include wherein a length of the audio sample is twenty milliseconds.

In Example 97, the subject matter of any one or more of Examples 78-96 optionally include wherein the PMIC operates on a clock separate from the integrated system.

In Example 98, the subject matter of Example 97 optionally includes wherein the clock operates at a reduced frequency than an integrated system clock.

In Example 99, the subject matter of Example 98 optionally includes wherein the reduced frequency is thirty-eight point four megahertz.

In Example 100, the subject matter of any one or more of Examples 78-99 optionally include wherein the PMIC is created with a sixty-five nanometer process.

In Example 101, the subject matter of any one or more of Examples 78-100 optionally include wherein the means for putting the integrated system to sleep include means for gating off a portion of the integrated system.

In Example 102, the subject matter of Example 101 optionally includes wherein the portion is the sensor circuit of the integrated system.

Example 103 is a system configured to perform operations of any one or more of Examples 1-102.

Example 104 is a method for performing operations of any one or more of Examples 1-102.

Example 105 is a machine readable medium including instructions that, when executed by a machine cause the machine to perform the operations of any one or more of Examples 1-102.

Example 106 is a system comprising means for performing the operations of any one or more of Examples 1-102.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first.” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for low power key phrase detection (KPD), the system comprising:
a sensor circuit in an integrated system; and
a power management integrated circuit (PMIC) that is physically different than the sensor circuit and has a low power leakage that the sensor circuit, the PMIC to:
capture an audio sample; and
transfer the audio sample to the integrated system to perform KPD when the integrated system is awake, wherein the integrated system is awoken upon a trigger, and wherein the integrated system is put to sleep in response to completion of the KPD.

2. The system of claim 1, wherein the PMIC includes a first-in-first-out (FIFO) buffer separate from other components of the integrated system, and wherein, to capture the audio sample, the PMIC is to store input from an array of microphones into the FIFO buffer.

3. The system of claim 1, wherein, to transfer the audio sample, the PMIC is to use a serial peripheral interface (SPI), the PMIC including a first SPI endpoint communicatively coupled to a second SPI endpoint in the integrated system.

4. The system of claim 1, wherein the PMIC is to transform the audio sample from a first format into a second format prior to transferring the audio sample to the integrated system.

5. The system of claim 1, wherein the trigger is activated at an interval determined by a timer.

6. The system of claim 1, wherein a length of the audio sample is twenty milliseconds.

7. The system of claim 1, wherein the PMIC operates on a clock separate from the integrated system.

8. The system of claim 1, wherein, to put the integrated system to sleep, the integrated system is to gate off a portion of the integrated system.

9. A method for low power key phrase detection (KPD), the method comprising:
capturing an audio sample in a power management integrated circuit (PMIC), the PMIC being physically different than a sensor circuit of an integrated system and having a lower power leakage than the sensor circuit;
waking the integrated system upon a trigger;
transferring the audio sample to the integrated system to perform KPD; and
putting the integrated system to sleep in response to completion of the KPD.

10. The method of claim 9, wherein the PMIC includes a first-in-first-out (FIFO) buffer separate from other components of the integrated system, and wherein capturing the audio sample includes storing input from an array of microphones into the FIFO buffer.

11. The method of claim 9, wherein transferring the audio sample includes using a serial peripheral interface (SPI), the PMIC including a first SPI endpoint communicatively coupled to a second SPI endpoint in the integrated system.

12. The method of claim 9, comprising transforming, by the PMIC, the audio sample from a first format into a second format prior to transferring the audio sample to the integrated system.

13. The method of claim 9, wherein the trigger is activated at an interval determined by a timer.

14. The method of claim 9, wherein a length of the audio sample is twenty milliseconds.

15. The method of claim 9, wherein the PMIC operates on a clock separate from the integrated system.

16. The method of claim 9, wherein putting the integrated system to sleep includes gating off a portion of the integrated system.

17. At least one machine readable medium including instructions for low power key phrase detection (KPD), the instructions, when executed by a machine, cause the machine to perform operations comprising:
capturing an audio sample in a power management integrated circuit (PMIC), the PMIC being physically different than a sensor circuit of an integrated system and having a lower power leakage than the sensor circuit;
waking the integrated system upon a trigger;
transferring the audio sample to the integrated system to perform KPD; and
putting the integrated system to sleep in response to completion of the KPD.

18. The at least one machine readable medium of claim 17, wherein the PMIC includes a first-in-first-out (FIFO) buffer separate from other components of the integrated system, and wherein capturing the audio sample includes storing input from an array of microphones into the FIFO buffer.

19. The at least one machine readable medium of claim 17, wherein transferring the audio sample includes using a serial peripheral interface (SPI), the PMIC including a first SPI endpoint communicatively coupled to a second SPI endpoint in the integrated system.

20. The at least one machine readable medium of claim 17, wherein the operations comprise transforming, by the PMIC, the audio sample from a first format into a second format prior to transferring the audio sample to the integrated system.

21. The at least one machine readable medium of claim 17, wherein the trigger is activated at an interval determined by a timer.

22. The at least one machine readable medium of claim 17, wherein a length of the audio sample is twenty milliseconds.

23. The at least one machine readable medium of claim 17, wherein the PMIC operates on a clock separate from the integrated system.

24. The at least one machine readable medium of claim 17, wherein putting the integrated system to sleep includes gating off a portion of the integrated system.
